(19) United States
(12) Patent Application Publication
(10) Pub. No.: US 2025/0199239 A1
(43) Pub. Date: Jun. 19, 2025

(54) OPTICAL DEVICE

(71) Applicants: SUMITOMO ELECTRIC INDUSTRIES, LTD., Osaka (JP); NATIONAL UNIVERSITY CORPORATION HOKKAIDO UNIVERSITY, Sapporo-shi (JP)

(72) Inventors: Naoki FUJIWARA, Osaka-shi (JP); Takuya MITARAI, Osaka-shi (JP); Takeshi FUJISAWA, Sapporo-shi (JP)

(73) Assignees: SUMITOMO ELECTRIC INDUSTRIES, LTD., Osaka (JP); NATIONAL UNIVERSITY CORPORATION HOKKAIDO UNIVERSITY, Sapporo-shi (JP)

(21) Appl. No.: 18/960,708

(22) Filed: Nov. 26, 2024

(30) Foreign Application Priority Data
Dec. 13, 2023 (JP) 2023-210538

(51) Int. Cl. G02B 6/124; G02B 6/12

(52) U.S. Cl. CPC G02B 6/124; G02B 2006/12107; G02B 2006/12152; G02B 2006/12164

(57) ABSTRACT

An optical device includes a substrate having a first region and a second region in a surface thereof, a first waveguide for inputting light, and at least one second waveguide for outputting light. The second region surrounds the first region. The first waveguide and the second waveguide are optically coupled to the first region. The substrate includes a first layer and a second layer sequentially stacked one on top of the other in the first region. The second layer has a plurality of holes. A depth of each of the holes is half of a thickness of the second layer or smaller. The substrate does not have the second layer and has the first layer in the second region.

### CROSS REFERENCE TO RELATED APPLICATIONS

This application claims priority based on Japanese Patent Application No. 2023-210538 filed on Dec. 13, 2023, and the entire contents of the Japanese patent application are incorporated herein by reference.

### TECHNICAL FIELD

The present disclosure relates to an optical device.

### BACKGROUND

A mosaic type optical device having a plurality of holes provided in the surface of a substrate has been developed (see non-patent literature 1: “Deep Learning Enabled Design of Complex Transmission Matrices for Universal Optical Components” Nicholas J. Dinsdale et. al. ACS Photonics 2021, 8, 283-295).

### SUMMARY

An optical device according to the present disclosure includes a substrate having a first region and a second region in a surface thereof, a first waveguide configured to input light, and at least one second waveguide configured to output light. The second region surrounds the first region. The first waveguide and the second waveguide are optically coupled to the first region. The substrate includes a first layer and a second layer sequentially stacked one on top of the other in the first region. The second layer has a plurality of holes. A depth of each of the holes is half of a thickness of the second layer or smaller. The substrate does not have the second layer and has the first layer in the second region.

### BRIEF DESCRIPTION OF THE DRAWINGS

FIG. 1 is a plan view illustrating an optical device according to a first embodiment.

FIG. 2 is an enlarged schematic plan view of multiplexer/demultiplexer.

FIG. 3A is a cross-sectional view taken along the line A-A of FIG. 2.

FIG. 3B is a cross-sectional view taken along the line B-B of FIG. 2.

FIG. 3C is a cross-sectional view illustrating a grating coupler.

FIG. 4A is a cross-sectional view illustrating a method of manufacturing an optical device.

FIG. 4B is a cross-sectional view illustrating a method of manufacturing an optical device.

FIG. 5A is a cross-sectional view illustrating a method of manufacturing an optical device.

FIG. 5B is a cross-sectional view illustrating a method of manufacturing an optical device.

FIG. 6 is a cross-sectional view illustrating a multiplexer/demultiplexer according to a comparative example.

FIG. 7A is a plan view illustrating a multiplexer/demultiplexer according to a second embodiment.

FIG. 7B is a plan view illustrating a multiplexer/demultiplexer according to a second embodiment.

FIG. 7C is a plan view illustrating a multiplexer/demultiplexer according to a second embodiment.

FIG. 8A is a diagram illustrating the calculation result of a splitting ratio.

FIG. 8B is a diagram illustrating the calculation result of a splitting ratio.

FIG. 8C is a diagram illustrating the calculation result of a splitting ratio.

FIG. 9 is a diagram illustrating the calculation result of the loss of light.

FIG. 10A is a plan view illustrating a multiplexer/demultiplexer in which the depth of each of holes is set to 20 nm.

FIG. 10B is a plan view illustrating a multiplexer/demultiplexer in which the depth of each of holes is set to 20 nm.

FIG. 10C is a plan view illustrating a multiplexer/demultiplexer in which the depth of each of holes is set to 20 nm.

FIG. 11A is a plan view illustrating a multiplexer/demultiplexer in which the depth of each of holes is set to 70 nm.

FIG. 11B is a plan view illustrating a multiplexer/demultiplexer in which the depth of each of holes is set to 70 nm.

FIG. 11C is a plan view illustrating a multiplexer/demultiplexer in which the depth of each of holes is set to 70 nm.

FIG. 11D is a plan view illustrating a multiplexer/demultiplexer in which the depth of each of holes is set to 70 nm.

FIG. 11E is a plan view illustrating a multiplexer/demultiplexer in which the depth of each of holes is set to 70 nm.

FIG. 12A is a plan view illustrating a multiplexer/demultiplexer in which the depth of each of holes is set to 120 nm.

FIG. 12B is a plan view illustrating a multiplexer/demultiplexer in which the depth of each of holes is set to 120 nm.

FIG. 12C is a plan view illustrating a multiplexer/demultiplexer in which the depth of each of holes is set to 120 nm.

FIG. 13A is a diagram illustrating the calculation result of a splitting ratio.

FIG. 13B is a diagram illustrating the calculation result of a splitting ratio.

FIG. 13C is a diagram illustrating the calculation result of a splitting ratio.

FIG. 14 is a diagram illustrating the calculation result of the loss of light.

FIG. 15 is a diagram illustrating a spectrum.

FIG. 16 is a diagram illustrating a spectrum.

FIG. 17 is a diagram illustrating a spectrum.

FIG. 18 is a diagram illustrating the calculation result of a splitting ratio.

FIG. 19 illustrates the calculation result of the loss of light.

FIG. 20A is a diagram illustrating a spectrum.

FIG. 20B is a plan view illustrating a multiplexer/demultiplexer according to a third embodiment.

FIG. 21A is a diagram illustrating a spectrum.

FIG. 21B is a plan view illustrating a multiplexer/demultiplexer according to a third embodiment.

FIG. 22A is a diagram illustrating a spectrum.

FIG. 22B is a plan view illustrating a multiplexer/demultiplexer according to a third embodiment.

FIG. 23 is a plan view illustrating a mode converter according to a fourth embodiment.

FIG. 24A is a diagram illustrating a spectrum.

FIG. 24B is a plan view illustrating a mode converter according to a fourth embodiment.

FIG. 25A is a diagram illustrating a spectrum.

FIG. 25B is a plan view illustrating a mode converter according to a fourth embodiment.

### DETAILED DESCRIPTION

An optical device capable of branching light at a specific splitting ratio in accordance with a pattern of holes is known. However, the hole may increase the loss of light. Thus, it is an object to provide an optical device capable of suppressing the loss of light.

### DESCRIPTION OF EMBODIMENTS OF PRESENT DISCLOSURE

First, the contents of embodiments of the present disclosure will be listed and explained.

(1) An optical device according to an aspect of the present disclosure includes a substrate having a first region and a second region in a surface thereof, a first waveguide configured to input light, and at least one second waveguide configured to output light. The second region surrounds the first region. The first waveguide and the second waveguide are optically coupled to the first region. The substrate includes a first layer and a second layer sequentially stacked one on top of the other in the first region. The second layer has a plurality of holes. A depth of each of the holes is half of a thickness of the second layer or smaller. The substrate does not have the second layer and has the first layer in the second region. The loss of light can be suppressed.

(2) In the above (1), the depth of each of the holes may be 1/20 to ½ of the thickness of the second layer.. The loss of light can be suppressed.

(3) In the above (1) or (2), the depth of each of the holes may be ⅕ to ⅖ of the thickness of the second layer. The loss of light can be suppressed.

(4) In any one of the above (1) to (3), the first layer may be made of silicon oxide. The second layer may be made of silicon. The loss of light can be suppressed.

(5) In any one of the above (1) to (4), a planar shape of each of the holes may be rectangular. The loss of light can be suppressed.

(6) In any one of the above (1) to (5), a planar shape of the first region may be rectangular. Light can be confined in the rectangular first region, and loss can be suppressed.

(7) In any one of the above (1) to (6), the first waveguide may be a single waveguide. The at least one second waveguide may include a plurality of second waveguides. Light can be branch.

(8) In any one of the above (1) to (7), a mode of the light input to the first waveguide may be different from a mode of the light output from the second waveguide. The mode of light can be converted.

(9) In any one of the above (1) to (8), the optical device may include a grating coupler connected to at least one of the first or second waveguides. The grating coupler may be formed at the second layer and may have protrusions and recesses formed on and in the second layer. The depth of each of the holes may be equal to a depth of each of the protrusions and recesses. Holes and protrusions and recesses can be formed simultaneously.

(10) In any one of the above (1) to (9), the optical device may include an electrically insulating film configured to cover a side surface and an upper surface of the first region and configured to cover an upper surface of the second region. Light can be confined in the second layer of the first region.

### Details of Embodiments of Present Disclosure

Specific examples of a semiconductor device according to embodiments of the present disclosure will be described below with reference to the drawings. It should be noted that the present disclosure is not limited to these examples, but is defined by the claims and is intended to include all modifications within the meaning and scope equivalent to the claims.

### First Embodiment

### (Optical Device)

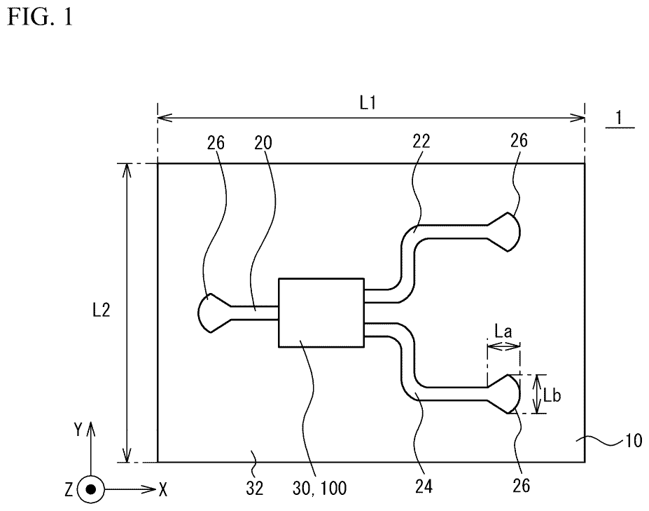

FIG. 1 is a plan view illustrating an optical device 1 according to a first embodiment. Optical device 1 includes a substrate 10, a multiplexer/demultiplexer 100, a waveguide 20, a waveguide 22, a waveguide 24, and three grating couplers 26. In the plan view, a cladding layer covering optical device 1 is seen through.

Substrate 10 is, for example, a silicon on insulator (SOI) substrate. Two sides of substrate 10 are parallel to the X-axis direction. The other two sides are parallel to the Y-axis direction. The upper surface of substrate 10 is parallel to the XY plane surface. The Z-axis direction is a normal direction of substrate 10. The X-axis direction, the Y-axis direction, and the Z-axis direction are orthogonal to each other. A length L1 of substrate 10 in the X-axis direction is, for example, 300 μm. A length L2 in the Y-axis direction is, for example, 150 μm.

Substrate 10 includes a region 30 (first region) and a region 32 (second region). Region 30 is located at the center of substrate 10. Region 32 is located outside region 30 and surrounds region 30. Multiplexer/demultiplexer 100 is provided in region 30.

Waveguide 20, waveguide 22, and waveguide 24 are optically coupled to multiplexer/demultiplexer 100. Waveguide 20 (first waveguide) is connected to one end of multiplexer/demultiplexer 100. Waveguide 22 and waveguide 24 (second waveguide) are connected to another end of multiplexer/demultiplexer 100. Grating couplers 26 are connected to each of waveguide 20, waveguide 22, and waveguide 24 at a portion opposite to multiplexer/demultiplexer 100. Waveguide 20, waveguide 22, waveguide 24, and grating couplers 26 are provided in region 32. A length La of grating coupler 26 in the X-axis direction is, for example, 60 μm. A length Lb in the Y-axis direction is, for example, 30 μm.

In one example of the present disclosure, multiplexer/demultiplexer 100 is a power multiplexer/demultiplexer. The power multiplexer/demultiplexer is an element that branches input light into multiple lights at a certain intensity ratio and outputs the multiple lights, or an element that combines multiple input light lights and outputs one or multiple lights. In another example of the present disclosure, the multiplexer/demultiplexer is a mode divider. The mode divider is an element that, when light having a specific polarization is input, converts a portion of the light into light having another polarization at a certain ratio, and branches the light into the light having the specific polarization and the light having the another polarization to output the light. In yet another example of the present disclosure, the multiplexer/demultiplexer is a mode converter. The mode converter is an element that converts light having a specific polarization into light having another polarization and outputs the light when the light having the specific polarization is input.

### (Multiplexer/Demultiplexer)

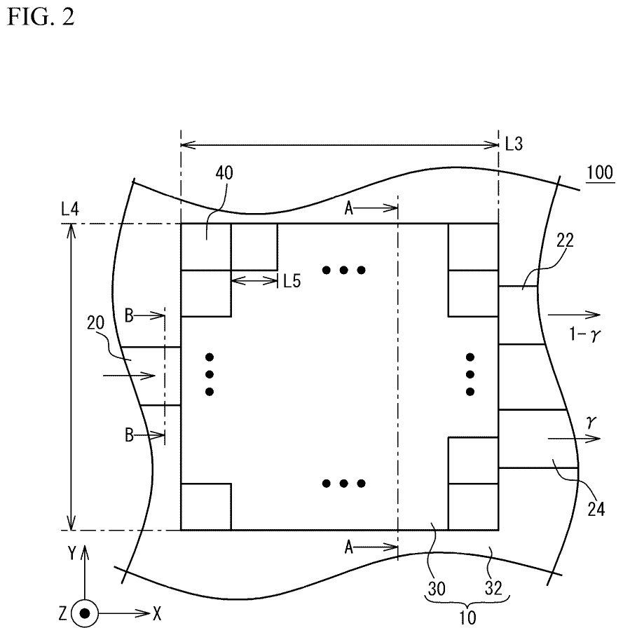

FIG. 2 is an enlarged schematic plan view of multiplexer/demultiplexer 100.
Multiplexer/demultiplexer 100 is disposed in region 30 of substrate 10. The planar shape of region 30 is rectangular. Region 32 is located outside region 30.

Multiplexer/demultiplexer 100 is a passive optical device of mosaic type. The mosaic type means a configuration in which a plurality of holes 40 are two dimensionally arranged in the surface. Multiplexer/demultiplexer 100 branches and outputs incident light having a specific wavelength, or multiplexes and outputs multiple incident light having the same wavelength. The planar shape of multiplexer/demultiplexer 100 is, for example, rectangular. A length L3 of multiplexer/demultiplexer 100 in the X-axis direction is, for example, 32 μm. A length L4 in the Y-axis direction is, for example, 6 μm.

Multiplexer/demultiplexer 100 is provided with the plurality of holes 40. The plurality of holes 40 are two dimensionally arranged in the XY plane and are arranged along the X-axis direction and the Y-axis direction. The planar shape of each of holes 40 is, for example, rectangular. A length L5 of one side of hole 40 is, for example, 400 nm. The number and positions of holes 40 are determined according to the characteristics of multiplexer/demultiplexer 100. The characteristics are, for example, a splitting ratio, a mode of output light, or the like.

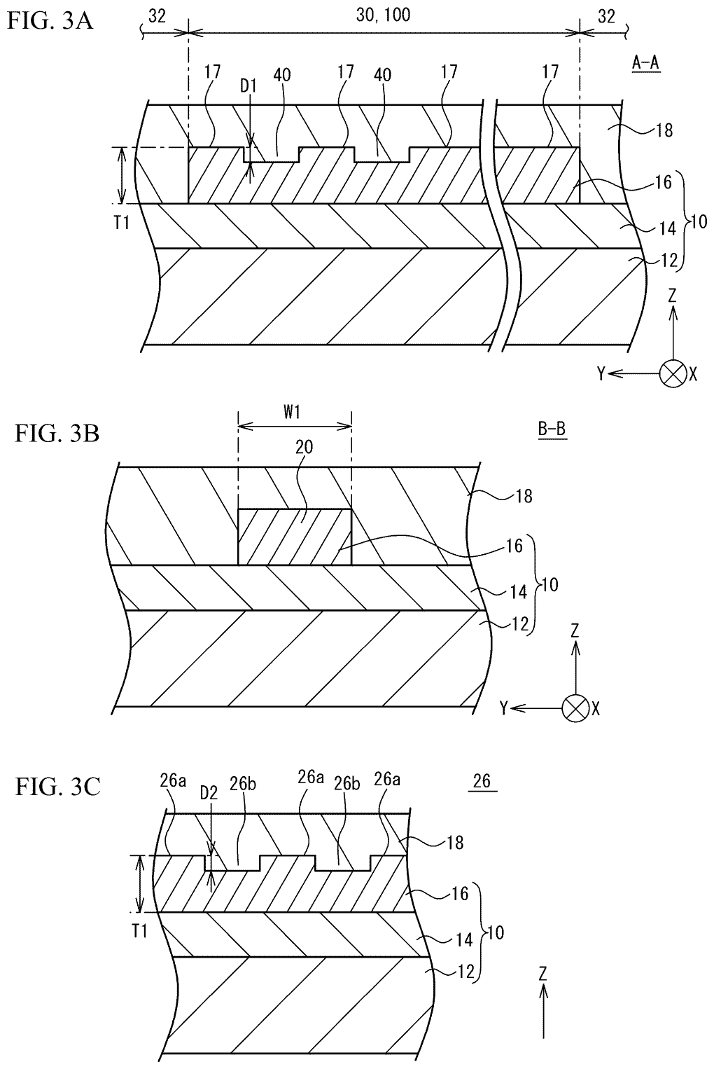

FIG. 3A is a cross-sectional view taken along the line A-A of FIG. 2. FIG. 3B is a cross-sectional view taken along the line B-B of FIG. 2. As illustrated in FIGS. 3A and 3B, substrate 10 is an SOI substrate, and includes a substrate 12, a BOX layer 14 (first layer), and a silicon layer 16 (second layer).

As illustrated in FIG. 3A, multiplexer/demultiplexer 100 is formed in region 30 of substrate 10. Silicon layer 16 is provided in region 30. BOX layer 14 is stacked on one surface of substrate 12. Silicon layer 16 is stacked on the surface of BOX layer 14 opposite to substrate 12. A thickness T1 of the thicker portion of silicon layer 16 is, for example, 220 nm. A cladding layer 18 (electrically insulating film) is stacked on the surface of silicon layer 16 opposite to BOX layer 14. Substrate 12 and silicon layer 16 are made of silicon (Si). BOX layer 14 and cladding layer 18 are made of an insulator such as silicon oxide (SiO₂). The thickness of BOX layer 14 is, for example, 3 μm. The refractive index of silicon is about 3.46 at the wavelength of 1.55 μm. The refractive index of SiO₂ is about 1.46 at the wavelength of 1.55 μm. The refractive index of silicon layer 16 is higher than the refractive index of BOX layer 14 and cladding layer 18. In the Y-axis direction, silicon layer 16 is not provided in region 32 which is in contact with region 30, and substrate 12 and BOX layer 14 are provided.

As illustrated in FIG. 3A, the plurality of holes 40 are formed in silicon layer 16. A portion of silicon layer 16 where hole 40 is not provided is referred to as a terrace 17. The thickness of silicon layer 16 at the position of terrace 17 is T1. In the Z-axis direction, holes 40 are recessed below terrace 17. A depth D1 of each of holes 40 from the upper surface of terrace 17 is half of the thickness T1 of silicon layer 16 or smaller. When the thickness T1 is 220 nm, the depth D1 is 110 nm or less, or may be, for example, 50 nm to 100 nm, or 70 nm.

Cladding layer 18 covers the upper surface and the side surfaces of silicon layer 16. Hole 40 may be filled with cladding layer 18 or may contain air without being filled with cladding layer 18. The positions and the number of holes 40 are determined according to the characteristics. The number of holes 40 is, for example, several tens, several hundreds, or one thousand or more.

As illustrated in FIG. 3B, waveguide 20 is formed of silicon layer 16. The cross-sectional shape of waveguide 20 is rectangular. A width W1 of waveguide 20 is, for example, 1 μm. The thickness of waveguide 20 is as same as terrace 17 of silicon layer 16, and is, for example, 220 nm. The upper surface and side surfaces of waveguide 20 are covered with cladding layer 18. Waveguide 22 and waveguide 24 have the same configuration as waveguide 20.

### (Grating Coupler)

FIG. 3C is a cross-sectional view illustrating grating coupler 26. Grating coupler 26 is provided on silicon layer 16 and has protrusions and recesses. That is, a plurality of protruding portions 26a and a plurality of recessed portions 26b are alternately arranged. The thickness of silicon layer 16 in protruding portion 26a is equal to the thickness T1 of terrace 17. A depth D2 from the upper surface of protruding portion 26a to the bottom surface of recessed portion 26b is equal to the depth D1 of each of holes 40, and is, for example, 70 nm.

As illustrated in FIG. 1, three waveguides 20, 22 and 24 are connected to multiplexer/demultiplexer 100. Light is incident on waveguide 20 from grating coupler 26. As illustrated by the arrows in FIG. 2, the light propagates through waveguide 20 and is input to multiplexer/demultiplexer 100. The insides of holes 40 are filled with cladding layer 18 made of SiO₂. The refractive index of hole 40 is different from the refractive index of silicon layer 16. The light is scattered and branch in the surface including substrate 10 and cladding layer 18. A portion of the light is output from waveguide 22. Another portion of the light is output from waveguide 24. When a splitting ratio of light is γ, and light of intensity 1 is input to waveguide 20, the intensity of light output from waveguide 24 is γ, and the intensity of light output from waveguide 22 is 1−γ. γ is a numerical value of 1 or less. The light emitted from waveguide 22 and waveguide 24 are output through grating coupler 26.

The arrangement of the plurality of holes 40 may be designed according to the desired splitting ratio. A pattern corresponding to the desired splitting ratio may be designed by repeatedly performing simulation calculation of the splitting ratio while changing the pattern of holes 40.

### (Manufacturing Method)

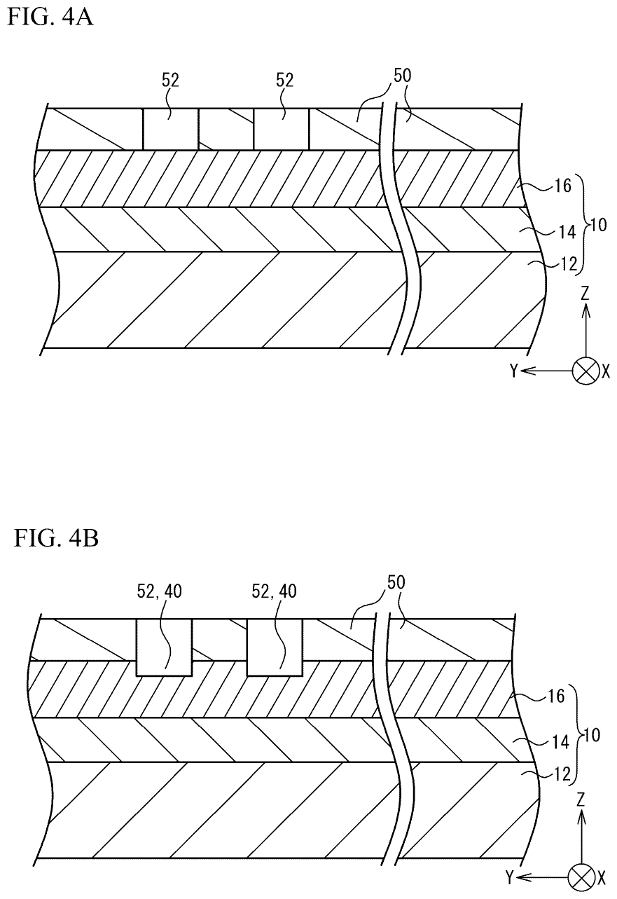

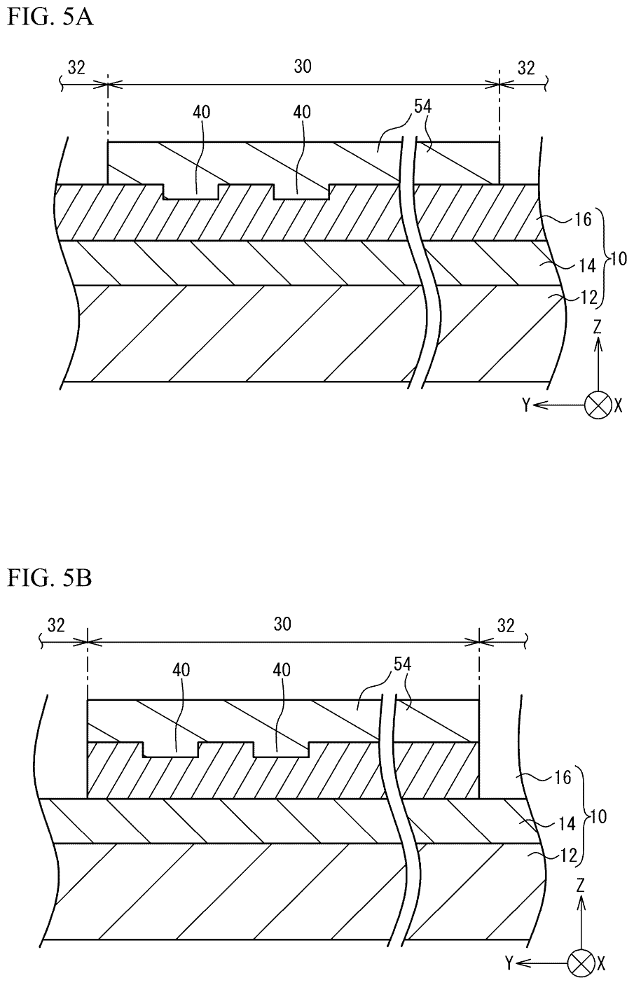

FIGS. 4A to 5B are cross-sectional views illustrating a method of manufacturing optical device 1, and illustrate cross-sectional surfaces corresponding to FIG. 3A.

As illustrated in FIG. 4A, a resist is coated on the upper surface of silicon layer 16, and photolithography is performed using a stepper to form a resist mask 50. Resist mask 50 is patterned according to the designed arrangement of holes 40, and an opening 52 are formed. Silicon layer 16 is exposed from opening 52.

As illustrated in FIG. 4B, dry etching is performed to form holes 40 in silicon layer 16. A portion of silicon layer 16 exposed from opening 52 of resist mask 50 is etched to form hole 40. The etching depth is half of the thickness of silicon layer 16 or smaller, and is, for example, 70 nm. Silicon layer 16 remains between the bottom surface of hole 40 and the upper surface of BOX layer 14, and the thickness of silicon layer 16 is 150 nm. The portion of silicon layer 16 covered with resist mask 50 is not etched.

Although not illustrated, resist mask 50 has an opening also in a portion where grating coupler 26 is manufactured. A portion of silicon layer 16 exposed from the opening is dry etched to, for example, depth of 70 nm. Simultaneously with the manufacturing of holes 40, recessed portions 26b of grating coupler 26 are also formed. No waveguide is formed in this step. After holes 40 and recessed portions 26b are manufactured, resist mask 50 is removed.

As illustrated in FIG. 5A, a resist is coated on the upper surface of silicon layer 16, and photolithography is performed to form a resist mask 54. Resist mask 54 is rectangular and covers region 30. In the Y-axis direction, silicon layer 16 of region 32 in contact with region 30 is exposed from resist mask 54.

As illustrated in FIG. 5B, dry etching is performed to remove the portion of silicon layer 16 exposed from resist mask 54. Silicon layer 16 is removed from region 32, and BOX layer 14 is exposed to atmosphere. Silicon layer 16 remains in region 30.

Although not illustrated, resist mask 54 is patterned also in a portion where the waveguide is manufactured. Resist mask 54 covers a portion of silicon layer 16 where a waveguide is to be formed. After the dry etching, a waveguide is formed in a portion where silicon layer 16 remains. After the dry etching, resist mask 54 is removed. Cladding layer 18 is deposited. Cladding layer 18 covers the upper surface and the side surface of region 30, the upper surface of region 32, and the waveguide. Optical device 1 is manufactured by the above steps.

### COMPARATIVE EXAMPLE

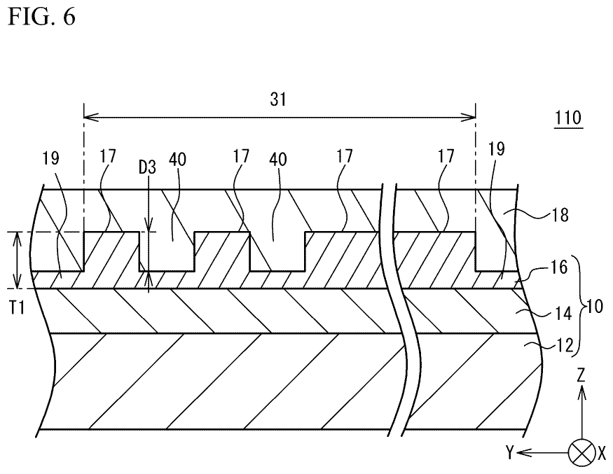

FIG. 6 is a cross-sectional view illustrating a multiplexer/demultiplexer 110 according to a comparative example. Substrate 10 includes a region 31. The plurality of holes 40 are provided in region 31. A depth D3 of each of holes 40 is larger than the depth D1 in FIG. 3A and larger than half of the thickness T1 of silicon layer 16. When the thickness T1 is 220 nm, the depth D3 is larger than 110 nm, for example. Silicon layer 16 has ribs 19. Rib 19 protrudes outside region 31 in the XY plane. The distance from the upper surface of rib 19 to the upper surface of terrace 17 is equal to the depth D3, for example.

Since holes 40 of the comparative example is deep, the mode of the light guided through multiplexer/demultiplexer 110 is close to vertical symmetry in the Z-axis direction. However, about half of the mode of light leaks into cladding layer 18 in the Z-axis direction. Deep holes 40 strongly scatter light, and silicon ribs 19 allow the scattered light to leak out of multiplexer/demultiplexer 110 in the XY plane. The loss of light increases.

According to the first embodiment, substrate 10 has region 30 and region 32. As illustrated in FIG. 3A, BOX layer 14 and silicon layer 16 are stacked in region 30. As illustrated in FIG. 2, the plurality of holes 40 are provided in silicon layer 16. The depth D1 of each of holes 40 is half of the thickness T1 of silicon layer 16 at the position of terrace 17 or smaller. The mode of light is less likely to leak in the thickness direction. The light scattering by shallow holes 40 is weaker than the light scattering by the deep holes. As illustrated in FIG. 3A, in the cross-section of the Y-axis direction, substrate 10 does not have silicon layer 16 in region 32 in the vicinity of multiplexer/demultiplexer 100. In the XY plane, light is strongly confined in region 30 and is less likely to leak to the outside. Since light is scattered by shallow holes 40 in region 30, the loss of light can be suppressed.

Scattering by shallow holes 40 is weaker than scattering by the deep holes. According to the first embodiment, light is confined in region 30, and thus light is less likely to leak to the outside. The light confined in region 30 is scattered by the plurality of holes 40, and thus the light can be branch at the desired splitting ratio.

The depth D1 of each of holes 40 may be 1/20 to ½ of the thickness T1 of silicon layer 16, or may be ⅕ to ⅖ of the thickness T1. When the thickness T1 is 220 nm, the depth D1 is 11 nm to 110 nm, 44 nm to 88 nm, or the like. The loss of light can be suppressed.

As illustrated in FIG. 3A, substrate 10 is, for example, an SOI substrate, and includes substrate 12, BOX layer 14, and silicon layer 16. In region 30, substrate 12, BOX layer 14, and silicon layer 16 are stacked in this order. In region 32, substrate 12 and BOX layer 14 made of SiO₂ are stacked. Silicon layer 16 is not provided in the vicinity of multiplexer/demultiplexer 100 except for waveguide 20, waveguide 22, and waveguide 24. Light can be strongly confined to region 30 and can be scattered within multiplexer/demultiplexer 100. It is possible to suppress the loss of light, and branch light.

As illustrated in FIG. 2, the planar shape of region 30 of substrate 10 is rectangular. Region 32 surrounds region 30. Light can be confined in rectangular region 30, and loss can be suppressed. Region 30 may have a polygonal shape, a circular shape, or an elliptical shape, in addition to the rectangular shape. Substrate 10 may be a substrate other than an SOI substrate. The layers included in substrate 10 may be made of a material other than SiO₂ and Si. It is sufficient that one layer of substrate 10 is provided in region 30 and the plurality of holes 40 are provided in the one layer.

As illustrated in FIG. 2, the planar shape of each of holes 40 is rectangular. By two dimensionally arranging a plurality of rectangular holes 40, light can be branched. The planar shape of each of holes 40 may be circular, elliptical, polygonal, or the like.

The length L5 of one side of hole 40 is several hundred nm, and is, for example, 400 nm. When a design value of the splitting ratio is the same, the positions of the plurality of holes 40 do not change greatly even if the size of holes 40 changes. However, when hole 40 is too large, the splitting ratio may deviate from the design value. When hole 40 is too small, it is difficult to manufacture hole 40 with high precision by dry etching or the like. Length L5 of hole 40 is set to be, for example, 50 nm to 1000 nm. Hole 40 is manufactured, and the splitting ratio can be made to approach the design value.

Multiplexer/demultiplexer 100 is a one-input-and-two-output element, and includes waveguide 20, waveguide 22, and waveguide 24. Light is input from waveguide 20. Light is scattered by the plurality of holes 40. Light is output from waveguide 22 and waveguide 24. The light can be branch at the desired splitting ratio. The light input from waveguide 22 and waveguide 24 may be combined and output from waveguide 20. The number of output waveguides may be one or two or more.

The mode of the light input to waveguide 20 may be the same as the mode of the light output from waveguide 22 and the mode of the light output from waveguide 24, or may be different from at least one of the output modes.

As illustrated in FIG. 1, grating coupler 26 is coupled to the waveguide. The depth D2 of each of recessed portions 26b of grating coupler 26 may be equal to the depth D1 of each of holes 40. Holes 40 and recessed portions 26b can be simultaneously manufactured by one etching process. Grating coupler 26 may be coupled to all the waveguides or may be coupled to at least one waveguide. Optical device 1 do not have to include a grating coupler. Waveguide 20, waveguide 22, and waveguide 24 may extend to an end surface of optical device 1, and light may be input to and output from optical device 1 via the end surface.

Cladding layer 18 covers the side surfaces and the upper surface of region 30 and the upper surface of region 32. The refractive index of silicon layer 16 is higher than the refractive index of cladding layer 18 and BOX layer 14. Light is strongly confined in silicon layer 16 of region 30, and loss can be suppressed.

Hole 40 may be a cavity or cladding layer 18 may be embedded therein. The refractive index of hole 40 is different from the refractive index of silicon. The refractive index changes in the plane of substrate 10. Light can be branched.

### Second Embodiment

### (Example of D1=70 nm)

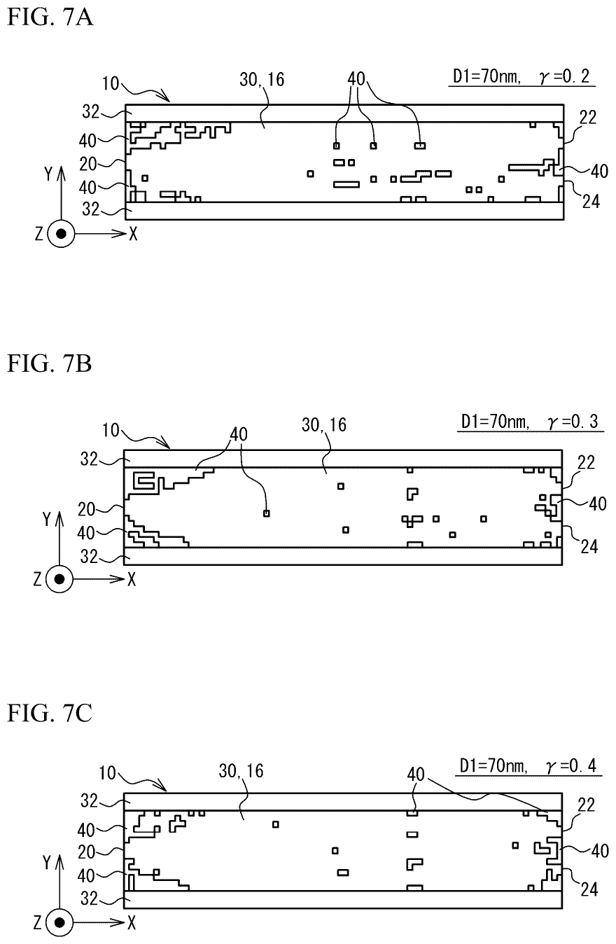

In the second embodiment, a splitting ratio γ is set to a specific value, and a multiplexer/demultiplexer is designed according to the splitting ratio. FIGS. 7A to 7C are plan views illustrating multiplexers/demultiplexers according to the second embodiment. The description of the same configuration as that of the first embodiment will be omitted.

Region 30 of substrate 10 includes silicon layer 16. Region 32 is located outside region 30 and does not have silicon layer 16 in the vicinity of the Y-axis direction of the multiplexer/demultiplexer. The length in the X-axis direction of silicon layer 16 of substrate 10 is 32 μm, and the length in the Y-axis direction is 6 μm. Silicon layer 16 of region 30 is divided into 400 nm×400 nm pixels. The number of pixels is 15×80. A part of the pixels are etched to form hole 40. Another part of the pixels are not etched and becomes terrace 17. A design value of the depth D1 of each of holes 40 is set to 70 nm, and design values of the splitting ratio γ are set to 0.2, 0.3, and 0.4. As illustrated in FIGS. 7A to 7C, the arrangement of the plurality of holes 40 is designed according to the splitting ratio. A plurality of adjacent holes 40 are continuous and form one recessed portion.

The multiplexer/demultiplexer of FIG. 7A is an example in which the splitting ratio is 0.2. The multiplexer/demultiplexer of FIG. 7B is an example in which the splitting ratio is 0.3. The multiplexer/demultiplexer of FIG. 7C is an example in which the splitting ratio is 0.4. In the example of FIG. 7A, when light is input to the multiplexer/demultiplexer from waveguide 20, ideally, 80% of the light is output from waveguide 22, and 20% of the light is output from waveguide 24. Other multiplexers/demultiplexers also output light according to the splitting ratio. These multiplexers/demultiplexers can be applied to optical device 1 of FIG. 1.

The splitting ratio and the loss of light are calculated by changing the depth of each of holes 40 to 20 nm, 50 nm, 70 nm, 100 nm, and 120 nm while maintaining the arrangement of holes 40 as designed. Substrate 10 is an SOI substrate, and the thickness of silicon layer 16 in a portion where hole 40 is not formed is set to 220 nm. The wavelength of light is set to 1550 nm.

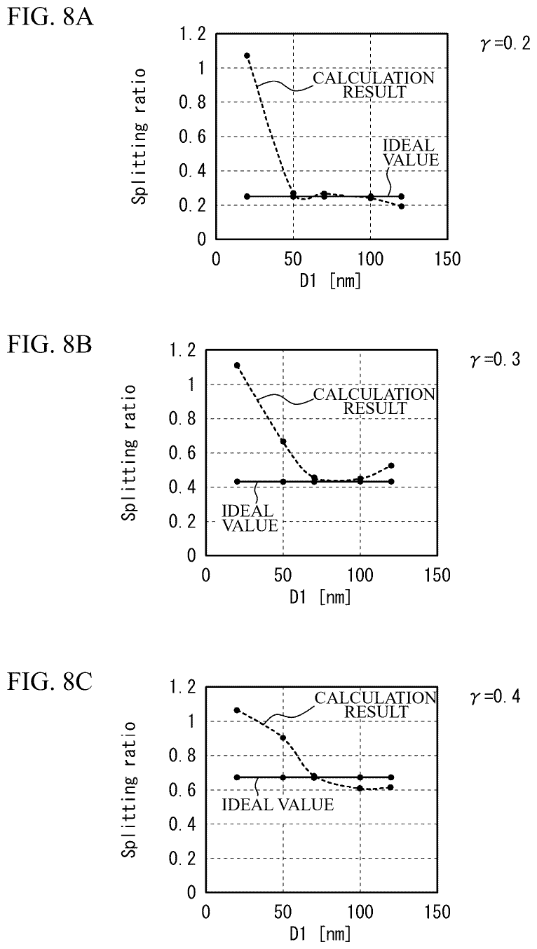

FIGS. 8A to 8C are diagrams illustrating the calculation result of the splitting ratio. The horizontal axis represents the depth D1 of hole 40. The vertical axis represents the splitting ratio (SR). When the splitting ratio is γ, the SR is expressed by the following equation.

SR=γ/(1−γ) (1)

If γ is 0.2, the SR is 0.25. If γ is 0.3, the SR is about 0.43. If γ is 0.4, the SR is about 0.67. If the splitting ratio γ is a designed value (ideal value), the SR also becomes the ideal value. When the splitting ratio γ deviates from the ideal value, the SR also becomes a value different from the ideal value. In FIGS. 8A to 8C, the solid line represents the ideal value of the splitting ratio. The dotted line represents the calculation result of the SR.

FIG. 8A illustrates the calculation result of the splitting ratio when the design value of the splitting ratio γ is 0.2. When the depth of each of holes 40 is 20 nm, the SR exceeds 1. This is because the splitting ratio γ is out of 0.2. In each of the examples of the depths of 50 nm, 70 nm, 100 nm, and 120 nm, the SR is close to the ideal values. This is because the splitting ratio γ is close to the design value of 0.2.

FIG. 8B illustrates the calculation result of the splitting ratio when the design value of the splitting ratio γ is 0.3. When the depth of each of holes 40 is 20 nm, the SR exceeds 1. When the depth is 50 nm, the SR is between 0.6 and 0.7. In each of the examples of the depths of 70 nm, 100 nm, and 120 nm, the SR is close to the ideal values. That is, the splitting ratio γ is close to the design value of 0.3.

FIG. 8C illustrates the calculation result of the splitting ratio when the design value of the splitting ratio γ is 0.4. When the depth of each of holes 40 is 20 nm, the SR exceeds 1. The closer the depth is to the designed value of 70 nm, the closer the SR is to the ideal value. The splitting ratio γ is close to the design value of 0.4.

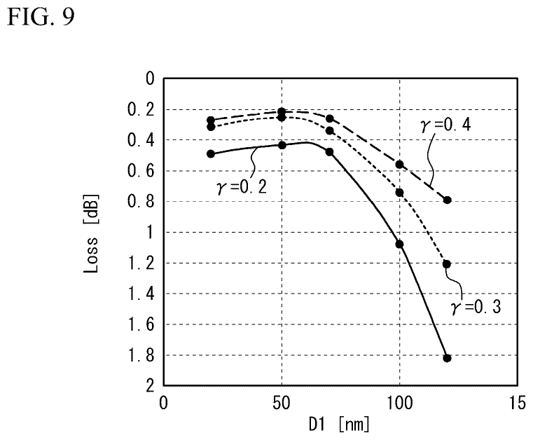

FIG. 9 is a diagram illustrating the calculation result of the loss of light. The horizontal axis represents the depth D1 of hole 40. The vertical axis represents the loss of light in the multiplexer/demultiplexer. The solid line represents the loss when the design value γ of the splitting ratio is 0.2. The dotted line represents the loss when γ is 0.3. The dashed line represents the loss when γ is 0.4. As illustrated in FIG. 9, the loss increases as hole 40 becomes deeper at any splitting ratio. The loss is reduced at the depth of 20 nm, 50 nm and 70 nm.

As illustrated in FIG. 9, when the depth of each of holes 40 is 100 nm or more, the loss increases. When the depth is 20 nm, the loss can be reduced. However, as illustrated in FIGS. 8A to 8C, the splitting ratio deviates from the ideal value. In the depth from 50 nm and 70 nm, the splitting ratio approaches the ideal value, and loss can be suppressed.

### (Redesign)

Next, the multiplexer/demultiplexer is redesigned for each depth of hole 40, and the splitting ratio and the loss are calculated. The depth D1 of each of holes 40 is set to 20 nm, 50 nm, 70 nm, 100 nm, or 120 nm, and the design value of the splitting ratio γ is set to 0.1, 0.2, 0.3, 0.4, or 0.5, and the multiplexer/demultiplexer is designed for each depth and splitting ratio. That is, the arrangement of the plurality of holes 40 is redesigned so that the splitting ratio at each depth approaches the desired splitting ratio γ as much as possible.

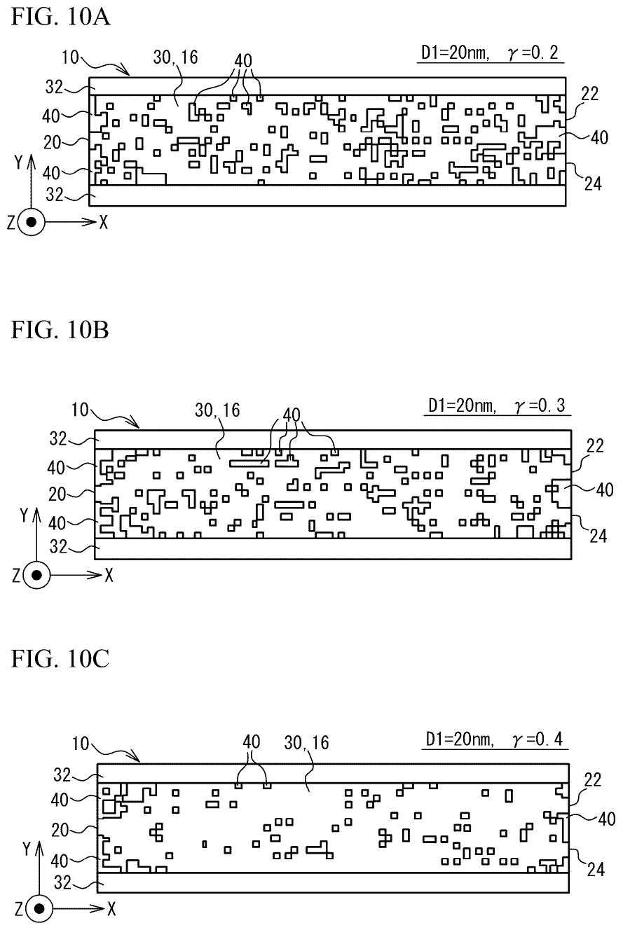

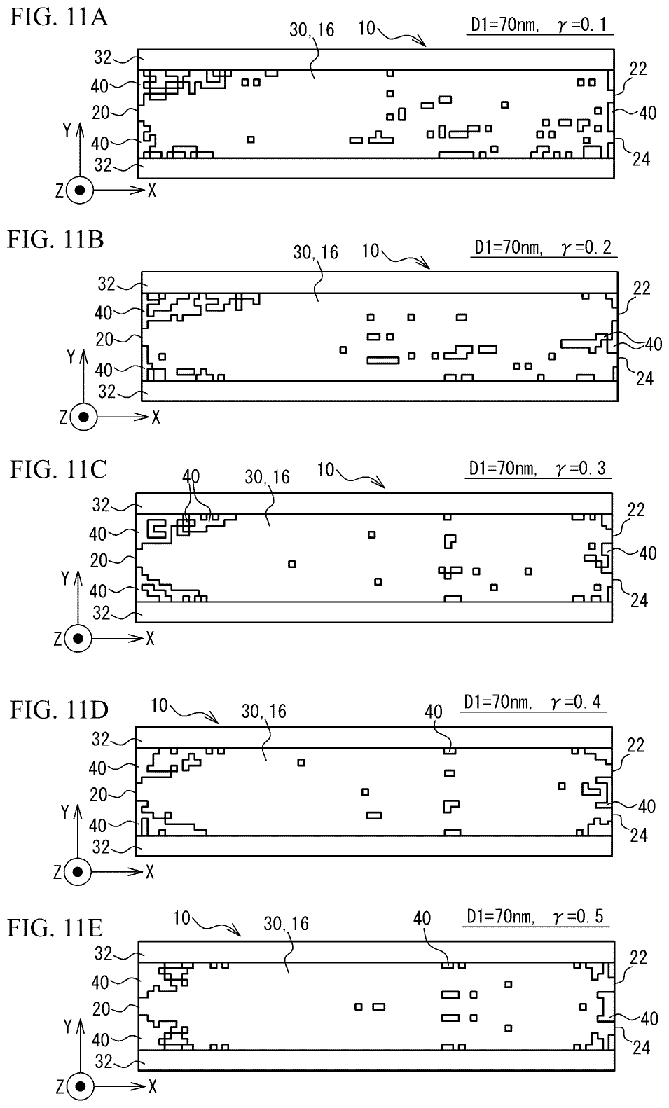

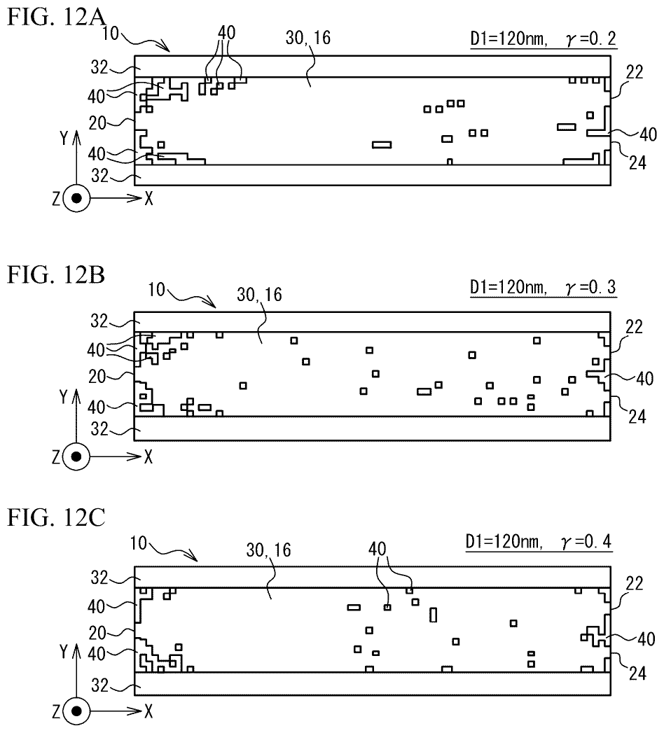

FIGS. 10A to 10C are plan views illustrating multiplexers/demultiplexers in which the depth D1 of each of holes 40 is set to 20 nm. FIGS. 11A to 11E are plan views illustrating multiplexers/demultiplexers in which the depth D1 of each of holes 40 is set to 70 nm. FIGS. 12A to 12C are plan views illustrating multiplexers/demultiplexers in which the depth D1 of each of holes 40 is set to 120 nm. FIG. 11A illustrate an example in which the design value of the splitting ratio γ is set to 0.1. FIGS. 10A, 11B, and 12A illustrate examples in which the design value of the splitting ratio γ is set to 0.2. FIGS. 10B, 11C, and 12B illustrate examples in which the design value of the splitting ratio γ is 0.3. FIGS. 10C, 11D, and 12C illustrate examples in which the design value of the splitting ratio γ is 0.4. FIG. 11E illustrates an example in which the design value of the splitting ratio γ is set to 0.5. A multiplexer/demultiplexer in which D1 is 50 nm or a multiplexer/demultiplexer in which D1 is 100 nm are not illustrated.

For example, as illustrated in FIGS. 10A, 11B, and 12A, when compared at the same splitting ratio (γ=0.2), the number of holes 40 increases as holes 40 become shallower, and the number of holes 40 decreases as holes 40 become deeper. Light is scattered more strongly by deep holes 40 than by shallow holes 40. Thus, the desired splitting ratio can be achieved with a small number of holes 40. Since the scattering by shallow holes 40 is weak, the desired splitting ratio is achieved with more holes 40.

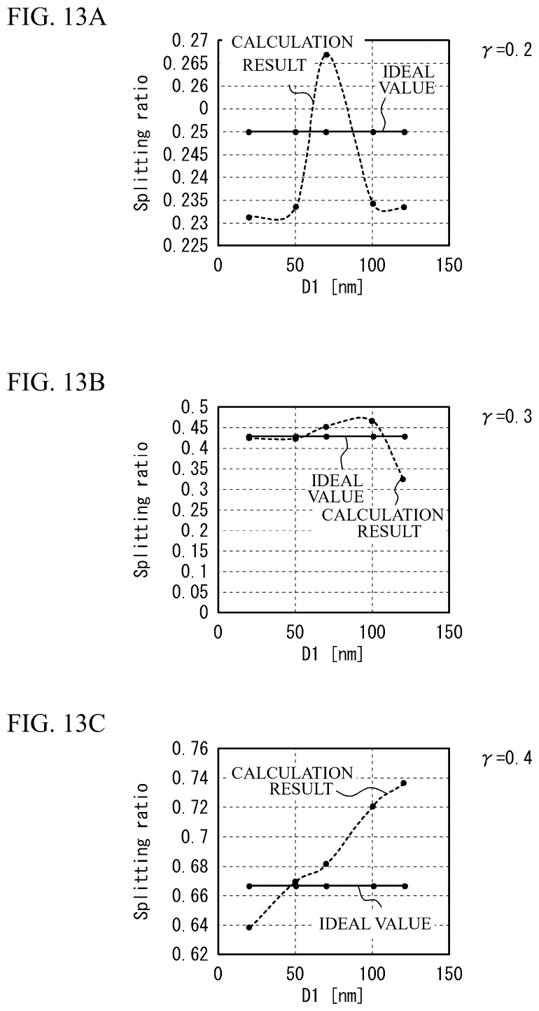

FIGS. 13A to 13C are diagrams illustrating the calculation results of the splitting ratios. The horizontal axis represents the depth D1 of hole 40. The vertical axis represents the splitting ratio (SR). In each of the drawings, a solid line represents an ideal value of the splitting ratio. The dotted line represents the calculation result of the SR.

FIG. 13A illustrates the calculation result of the splitting ratio when the design value of the splitting ratio γ is 0.2. At any depth, the calculated SR deviates from the ideal value by about 0.01. FIG. 13B illustrates the calculation result of the splitting ratio when the design value of the splitting ratio γ is 0.3. The deeper hole 40 is, the larger the deviation of the SR from the ideal value is. The shallower hole 40, the closer the SR approaches the ideal value. FIG. 13C illustrates the calculation result of the splitting ratio when the design value of the splitting ratio γ is 0.4. When the depth of holes 40 is 100 nm and 120 nm, the calculated value of the SR is greatly deviated from the ideal value. When the depth is 50 nm, the calculated value of the SR is closest to the ideal value.

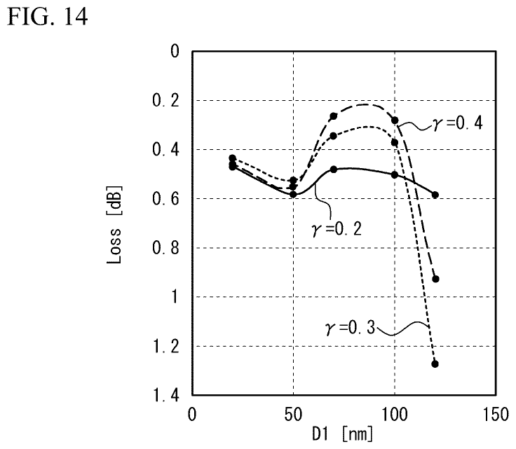

FIG. 14 is a diagram illustrating the calculation result of the loss of light. The horizontal axis represents the depth D1 of hole 40. The vertical axis represents the loss of light in the multiplexer/demultiplexer. The solid line represents the loss when the design value of the splitting ratio γ is 0.2. The dotted line represents the loss when γ is 0.3. The dashed line represents the loss when γ is 0.4. As illustrated in FIG. 14, in the example of γ is 0.2, the loss is within the range of 0.6 dB to 0.4 dB at any depth. In the example of γ is 0.3 and the example of γ is 0.4, the loss is large when the depth becomes 120 nm. At the depth of 20 nm to 100 nm, the loss is suppressed.

As illustrated in FIGS. 13B and 13C, when the depth D1 is 20 nm, 50 nm, or 70 nm, the splitting ratio is close to the ideal value. As illustrated in FIG. 14, when the depth D1 is 120 nm, the loss is large. When hole 40 is shallow, the loss is suppressed, and particularly when D1 is 70 nm or D1 is 100 nm, the loss is reduced. As illustrated in FIGS. 13A to 13C, even if the arrangement of holes 40 is searched for so as to approach the ideal value by changing the depth D1, the splitting ratio γ does not necessarily coincide with the ideal value. At the depth D1 near 70 nm, the calculated value of the SR does not deviate from the ideal value significantly at any splitting ratio, compared to other depths. When a multiplexer/demultiplexer having a plurality of splitting ratios γ is designed with the same hole depth D1, the depth D1 is preferably near 70 nm.

### (Wavelength Dependency)

The wavelength of the light is changed from 1520 nm to 1600 nm, and the multiplexer/demultiplexer characteristics are measured and calculated. The depth D1 of each of holes 40 is 70 nm. The splitting ratio γ is set to 0.1, 0.3, or 0.5, and the multiplexer/demultiplexer is designed.

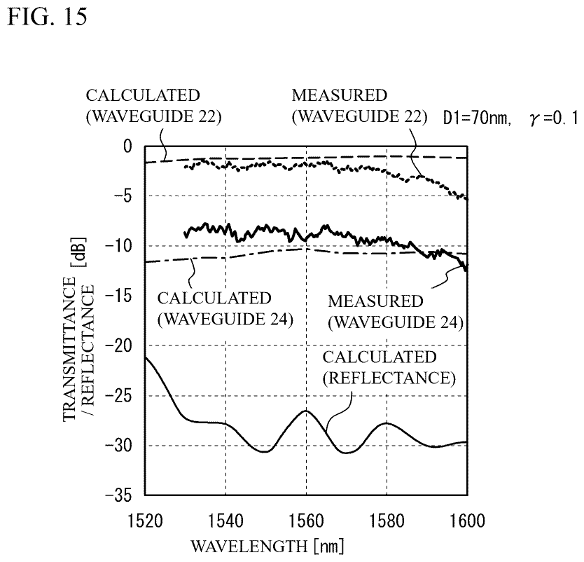

FIGS. 15 to 17 are diagrams illustrating spectra. The horizontal axis represents the wavelength of light. The vertical axis represents the transmittance or reflectance of light. The reflectance, the transmittance from waveguide 22, and the transmittance from waveguide 24 are illustrated. The dashed line represents the calculation result of the transmittance of waveguide 22. The dotted line represents the measurement result of the transmittance of waveguide 22. The one dot chain line represents the calculation result of the transmittance of waveguide 24. The solid line represents the measurement result of the transmittance of waveguide 24. The thin solid line represents the calculation result of reflectance. The reflectance is a ratio of light reflected by waveguide 20 when light is input from waveguide 20.

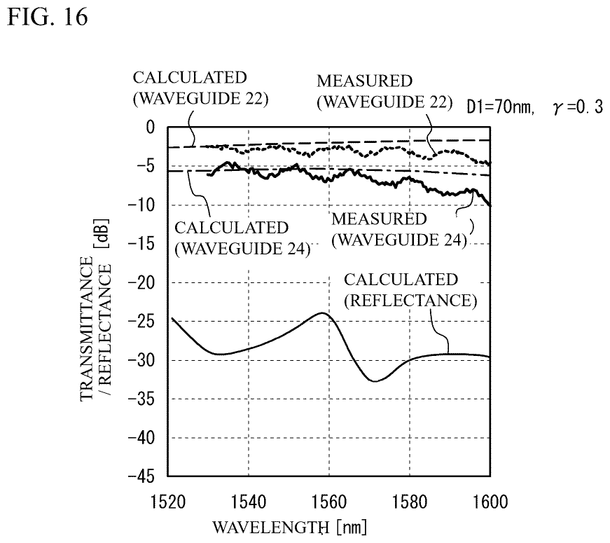

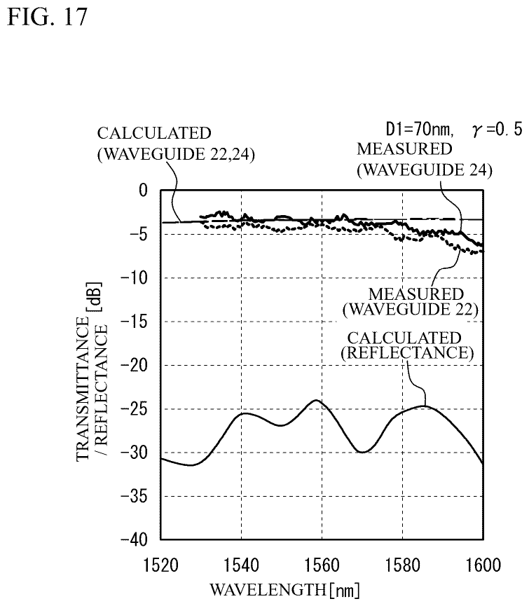

FIG. 15 is an example of γ is 0.1, and illustrates the spectrum in the multiplexer/demultiplexer of FIG. 11A. The ratio of the transmittance is ideally −0.46 dB:−10 dB. FIG. 16 is an example of γ is 0.3, and illustrates the spectrum in the multiplexer/demultiplexer of FIG. 11C. The ratio of the transmittance is ideally −1.54 dB:−5.23 dB. FIG. 17 is an example of γ is 0.5, and illustrates the spectrum in the multiplexer/demultiplexer of FIG. 11E. The ratio of the transmittance is ideally −3 dB:−3 dB. In each of the examples of FIGS. 15 to 17, the measurement result of the transmittance is close to the calculation result. It can be seen that the splitting ratio is close to a desired value in the wavelength range from 1520 nm to 1600 nm.

According to the second embodiment, the number and positions of holes 40 are designed according to the splitting ratio γ, thereby obtaining the desired splitting ratio. As illustrated in FIG. 9, the loss increases as hole 40 becomes deeper. In the depth D1 from 50 nm to 70 nm, the splitting ratio is close to the ideal value, and the loss can be suppressed. As illustrated in FIG. 14, when the depth D1 is 120 nm, the loss is large. When hole 40 is shallow, the loss is suppressed. That is, the depth D1 of each of holes 40 is set to be half of the thickness T1 of the thick portion of silicon layer 16 or smaller. When the thickness T1 is 220 nm, the depth D1 is set to, for example, 1/20 or more (11 nm or more), ⅕ or more (44 nm or more), and ⅖ or less (80 nm or less) of T1. The loss of light can be suppressed. As illustrated in FIGS. 15 to 17, when the depth D1 is set to 70 nm, the desired splitting ratio is realized in the wavelength range from 1520 nm to 1600 nm.

### Third Embodiment

The multiplexer/demultiplexer according to the third embodiment is a mode divider, which converts the mode of light and branches the light for each mode. The description of the same configuration as that of the first embodiment or the second embodiment will be omitted. The multiplexer/demultiplexer has a configuration similar to that illustrated in FIG. 2. The planar shape of the multiplexer/demultiplexer, the length in the X-axis direction, the length in the Y-axis direction, and the length of one side of hole 40 are the same as those of multiplexer/demultiplexer 100 of the first embodiment and the second embodiment. The width of the waveguide and the thickness of silicon layer 16 are the same as those of the first embodiment and the second embodiment. The arrangement of the plurality of holes 40 is different from that of the first embodiment and the second embodiment.

For example, the mode of the light input to waveguide 20 is the TE0 mode. The mode of the light output from waveguide 24 is the TE0 mode. The mode of the light output from waveguide 22 is the TE1 mode. When the splitting ratio is γ, and light of intensity 1 is input to waveguide 20, the intensity of light output from waveguide 24 is γ, and the intensity of light output from waveguide 22 is 1−γ.

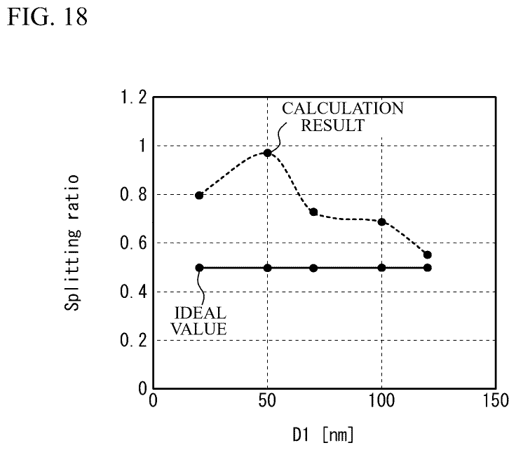

FIG. 18 is a diagram illustrating the calculation result of the splitting ratio. The horizontal axis represents the depth D1 of hole 40. The vertical axis represents the splitting ratio (SR). A multiplexer/demultiplexer is designed with D1 at 20 nm, 50 nm, 70 nm, 100 nm, 120 nm, and the splitting ratio is calculated. The wavelength of the light is 1550 nm. The SR at D1 of 50 nm is the furthest away from the ideal value. When D1 is 20 nm, 70 nm, 100 nm, and 120 nm, the SR approaches the ideal value.

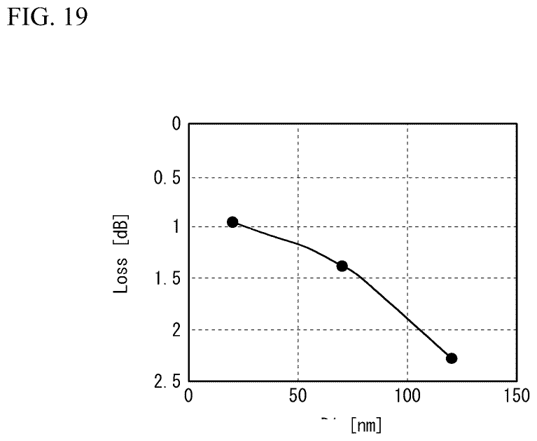

FIG. 19 illustrates the calculation result of the loss of light. The horizontal axis represents the depth D1 of hole 40. The vertical axis represents the calculation result of the loss of light. The loss is calculated when D1 is 20 nm, 70 nm, and 120 nm. As illustrated in FIG. 19, the shallower hole 40 is, the more the loss is suppressed.

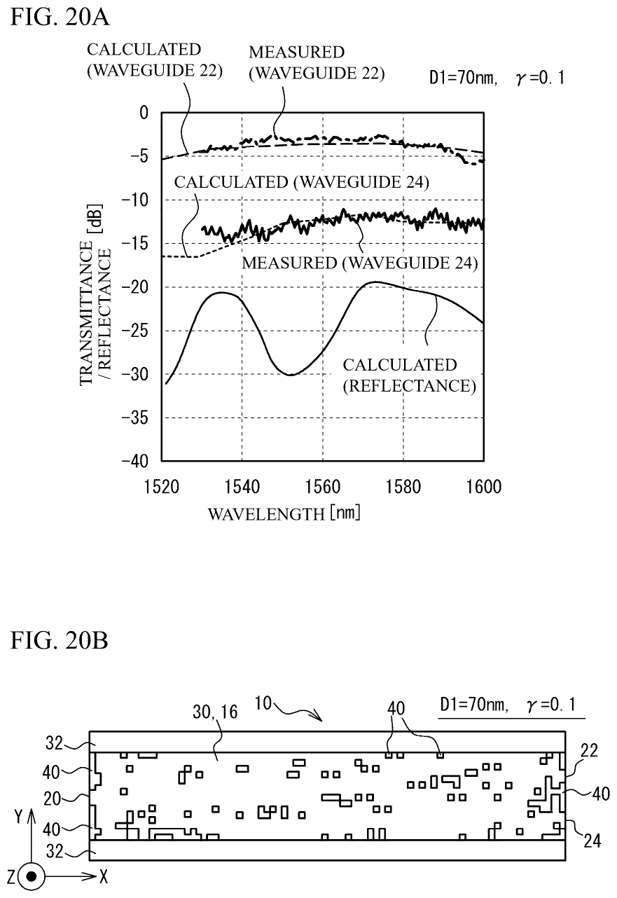

FIGS. 20A, 21A, and 22A are diagrams illustrating spectra. The horizontal axis represents the wavelength of light. The vertical axis represents the transmittance or reflectance of light. The reflectance, the transmittance from waveguide 22, and the transmittance from waveguide 24 are illustrated. The dashed line represents the calculation result of the transmittance of waveguide 22. The one dot chain line represents the measurement result of the transmittance of waveguide 22. The solid line represents the measurement result of the transmittance of waveguide 24. The dotted line represents the calculation result of the transmittance of waveguide 24. The thin solid line represents the calculation result of reflectance. The depth D1 of each of holes 40 is 70 nm. FIGS. 20B, 21B, and 22B are plan views illustrating multiplexers/demultiplexers according to the third embodiment.

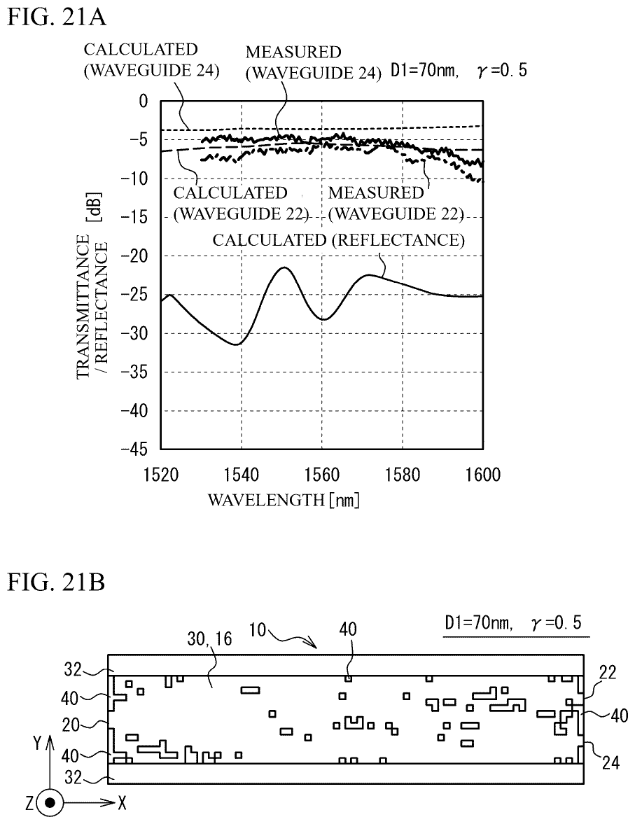

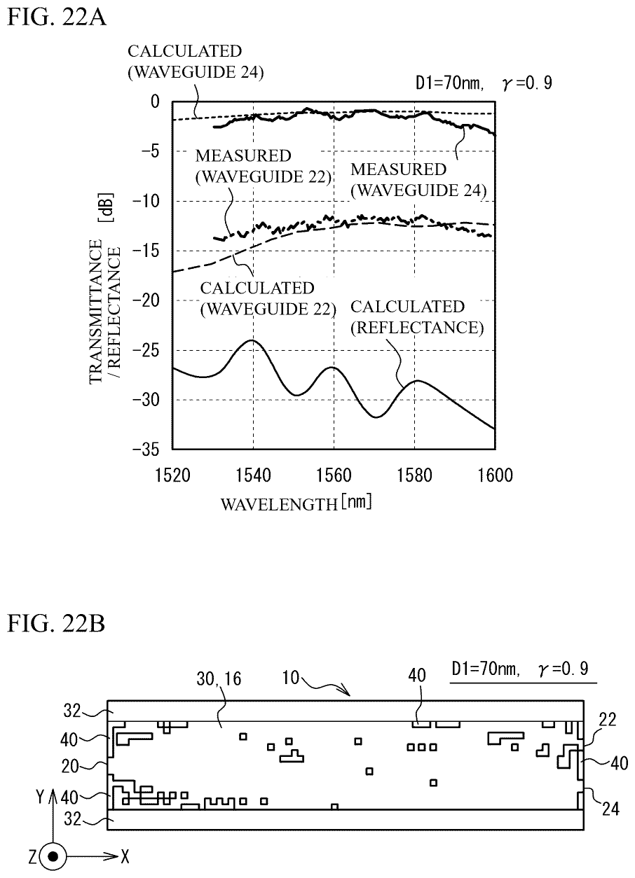

FIGS. 20A and 20B are examples where γ is 0.1. FIGS. 21A and 21B are examples where γ is 0.5. FIGS. 22A and 22B are examples where γ is 0.9. In each of the examples of FIGS. 20A, 21A, and 22A, the measurement result of the transmittance is close to the calculation result. It can be seen that the splitting ratio is close to a desired value in the wavelength range from 1520 nm to 1600 nm.

According to the third embodiment, the multiplexer/demultiplexer is a mode divider, which branches light and converts the mode of the light. The mode of the light input to waveguide 20 is different from the mode of the light output from waveguide 24. As illustrated in FIG. 19, in the mode divider, the loss can be suppressed by setting the depth D1 of each of holes 40 to be half of silicon layer 16 or smaller. As illustrated in FIGS. 20A, 21A, and 22A, the splitting ratio can be made closer to a desired value from the wavelength 1520 nm to 1600 nm. The mode divider of the third embodiment is designed by changing the arrangement and depth of holes 40 as compared with the power dividers of the first embodiment and the second embodiment, but other parameters are similar. While many of the same parameters are used, the few parameters of the arrangement and depth of holes 40 are determined by design. This allows different functions to be produced, namely a power divider and a mode divider.

### Fourth Embodiment

The fourth embodiment is an example of a mode converter. The description of the same configuration as that of any one of the first embodiment to the third embodiment will be omitted.

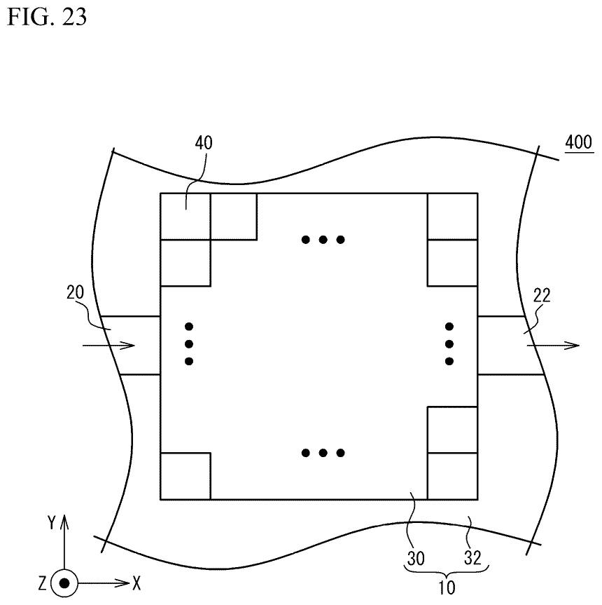

FIG. 23 is a plan view illustrating a mode converter 400 according to the fourth embodiment. Mode converter 400 includes waveguide 20 and waveguide 22. Waveguide 20 is a waveguide for input. Waveguide 22 is a waveguide for output. For example, a TE0 mode is input to waveguide 20. Mode converter 400 converts the mode of the light into a TE1 mode or a TE2 mode, and emits the light from waveguide 22. The length of mode converter 400 in the X-axis direction is 33.2 μm.

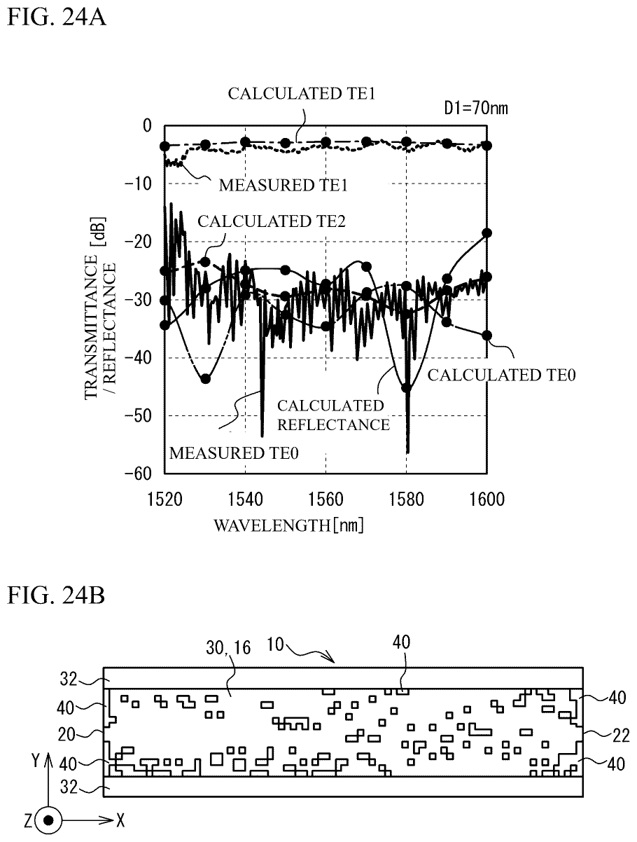

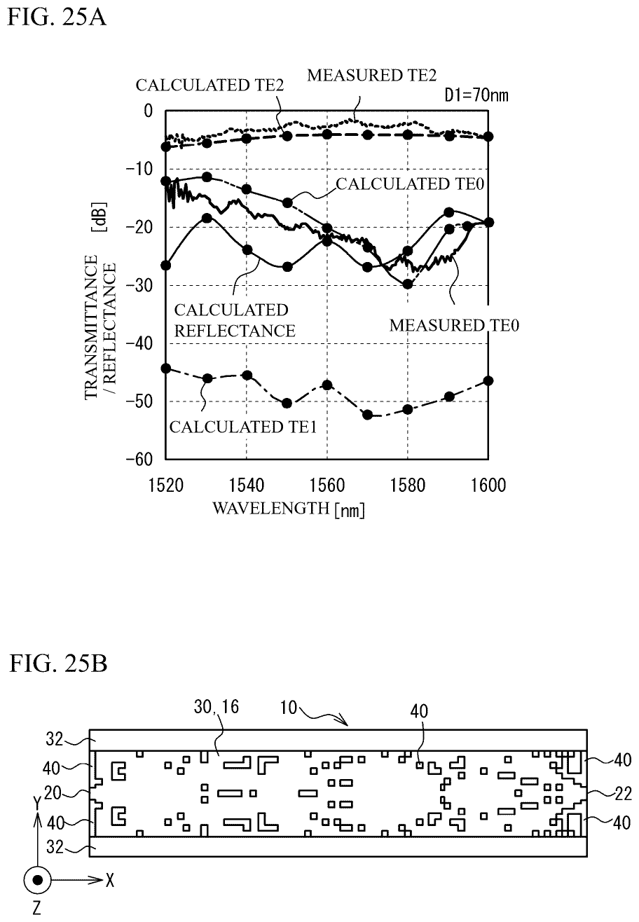

FIGS. 24A and 25A are diagrams illustrating spectra. The horizontal axis represents the wavelength of light. The vertical axis represents the transmittance or reflectance of light. The transmittance and reflectance of a TE0 mode, a TE1 mode and a TE2 mode are illustrated. The depth D1 of each of holes 40 is 70 nm. FIGS. 24B and 25B are plan views illustrating a mode converter according to the fourth embodiment.

In FIG. 24A, the dotted line represents the measurement result (TE1 measurement) of the transmittance of the TE1 mode. The one dot chain line represents the calculation result (TE1 calculation) of the transmittance of the TE1 mode. The dashed line represents the calculation result (TE2 calculation) of the transmittance of the TE2 mode. The solid line represents the measurement result (TE0 measurement) of the transmittance of the TE0 mode. The two dot chain line represents the calculation result (TE0 calculation) of the transmittance of the TE0 mode. The thin solid line represents the calculation result of reflectance. The measurement result of the transmittance of the TE1 mode is close to the calculation result.

In FIG. 25A, the dotted line represents the measurement result (TE2 measurement) of the transmittance of the TE2 mode. Others are the same as in FIG. 24A. The measurement result of the transmittance of the TE2 mode is close to the calculation result.

According to the fourth embodiment, the light in the TE0 mode is converted into the light in the TE1 mode or the TE2 mode and emitted. As illustrated in FIG. 24A, the transmittance of the TE1 mode is higher than the transmittance of the TE0 mode and the TE2 mode. As illustrated in FIG. 25A, the transmittance of the TE2 mode is higher than the transmittance of the TE0 mode and the TE1 mode. By setting the depth of each of holes 40 to be 70 nm, it is possible to suppress the loss and emit light of a desired mode.

In the third embodiment and the fourth embodiment, the input mode may be other than the TE0 mode. The output mode may be other than the TE1 mode and the TE2 mode.

Although the embodiments of the present disclosure have been described in detail, the present disclosure is not limited to the specific embodiments, and various modifications and changes can be made within the scope of the gist of the present disclosure described in the claims.

What is claimed is:

1. An optical device comprising:
a substrate having a first region and a second region in a surface thereof;
a first waveguide configured to input light; and
at least one second waveguide configured to output light,
wherein the second region surrounds the first region,
wherein the first waveguide and the second waveguide are optically coupled to the first region,
wherein the substrate includes a first layer and a second layer sequentially stacked one on top of the other in the first region,
wherein the second layer has a plurality of holes,
wherein a depth of each of the holes is half of a thickness of the second layer or smaller, and
wherein the substrate does not have the second layer and has the first layer in the second region.

2. The optical device according to claim 1,
wherein the depth of each of the holes is 1/20 to ½ of the thickness of the second layer.

3. The optical device according to claim 1,
wherein the depth of each of the holes is ⅕ to ⅖ of the thickness of the second layer.

4. The optical device according to claim 1,
wherein the first layer is made of silicon oxide, and
wherein the second layer is made of silicon.

5. The optical device according to claim 1,
wherein a planar shape of each of the holes is rectangular.

6. The optical device according to claim 1,
wherein a planar shape of the first region is rectangular.

7. The optical device according to claim 1,
wherein the first waveguide is a single waveguide, and
wherein the at least one second waveguide includes a plurality of second waveguides.

8. The optical device according to claim 1,
wherein a mode of the light input to the first waveguide is different from a mode of the light output from the second waveguide.

9. The optical device according to claim 1, comprising:
a grating coupler connected to at least one of the first or second waveguides,
wherein the grating coupler is formed at the second layer and has protrusions and recesses formed on and in the second layer, and
wherein the depth of each of the holes is equal to a depth of each of the protrusions and recesses.

10. The optical device according to claim 1, comprising:
an electrically insulating film configured to cover a side surface and an upper surface of the first region and configured to cover an upper surface of the second region.
